(19) United States
(12) Patent Application Publication
(10) Pub. No.: US 2025/0303543 A1
(43) Pub. Date: Oct. 2, 2025

(54) HAMMER HEAD WITH AN INTERCHANGABLE STRIKING FACE AND HAMMER THEREWITH

(71) Applicant: Daniel J. Raymond, Saginaw, MI (US)

(72) Inventor: Daniel J. Raymond, Saginaw, MI (US)

(21) Appl. No.: 19/089,672

(22) Filed: Mar. 25, 2025

Related U.S. Application Data
(60) Provisional application No. 63/569,910, filed on Mar. 26, 2024.

(51) Int. Cl. B25D 1/02; B25D 1/04

(52) U.S. Cl. CPC B25D 1/02; B25D 1/04

(57) ABSTRACT

A hammer and hammer head assembly therefor includes a head body extending lengthwise along a first axis between opposite first and second ends, generally transversely to a handle axis of a handle attached to the head body, with an insert releasably fixed to the head body by a key, wherein the insert defines a striking face and the key has a fastener bore extending in non-parallel relation with the first axis, and a fastener removably disposed in the fastener bore to releasably fix the insert against removal from the head body.

### CROSS-REFERENCE TO RELATED APPLICATION

This application claims the benefit of U.S. Provisional Application Ser. No. 63/569,910, filed Mar. 26, 2024, which is incorporated herein by way of reference in its entirety.

### BACKGROUND OF THE INVENTION

### 1. Field of the Invention

The present invention is related generally to hammers and is more particularly related to hammer head which provide multiple functions.

### 2. Related Art

In the construction industry, workers regularly use a number of different tools for various functions related to, such as, building framing and shaping and hanging drywall sheets. Sometimes the tools use for such functions include different types of hammers that have hammer heads having different uses, properties and configurations, such as having different types of striking faces made of different materials and/or shapes and configurations, or providing different weight balances.

### SUMMARY

In accordance with an object of the disclosure, a hammer in accordance with an aspect of the disclosure has an interchangeable striking face to allow the hammer to attain different properties and configurations, and to be used for different applications.

In accordance with another aspect of the present disclosure, a hammer head assembly has an interchangeable striking face to allow the hammer head assembly to attain different properties and configurations, and to be used for different hammer applications.

In accordance with another aspect of the present disclosure, a hammer head assembly includes a head body extending lengthwise along a first axis between opposite first and second ends; an insert defining a striking face; a key having a fastener bore extending in non-parallel relation with the first axis; and a fastener removably disposed in the fastener bore to releasably fix the insert against removal from the head body.

In accordance with another aspect of the present disclosure, the fastener bore extends in transverse relation with the first axis.

In accordance with another aspect of the present disclosure, the head body has a slot extending into the first end, the slot extending lengthwise along a second axis in non-parallel relation to the first axis, the insert having a front face and a back face with the key fixed to the back face, the key configured for sliding receipt along the second axis into the slot, the key being shaped to avoid removal from the slot along the first axis, the fastener bore extending into the key, the fastener releasably fixing the key against removal from the slot along the second axis.

In accordance with another aspect of the present disclosure, the second axis extends transversely to the first axis.

In accordance with another aspect of the present disclosure, the fastener bore has a threaded bore and the fastener has a threaded shank and an enlarged fastener head, the head body having a fastener opening, the fastener opening including a counterbore extending to a base and a through bore extending from the base to the slot, wherein the enlarged fastener head engages the base to releasably prevent removal of the key from the slot along the second axis.

In accordance with another aspect of the present disclosure, the through bore has a clearance fit with the threaded shank.

In accordance with another aspect of the present disclosure, the slot has tapered sidewalls converging toward the second axis.

In accordance with another aspect of the present disclosure, the key has tapered sidewalls mating with the tapered sidewalls of the slot.

In accordance with another aspect of the present disclosure, the fastener, upon being tightened, draws the tapered sidewalls of the key into mating engagement with the tapered sidewalls of the slot.

In accordance with another aspect of the present disclosure, the key is dovetail-shaped having a base fixed to the back face and a peak facing away from the back face, the key having a height extending from the base to the peak, the key having a length extending along the second axis between a first end face and a second end face, wherein the fastener bore extends into the second end face, and the key having a width extending between a first sidewall and a second sidewall, the first sidewall and the second sidewall extending from the base to the peak, the width having a first width adjacent the base and a second width adjacent the peak, the first width being less than the second width.

In accordance with another aspect of the present disclosure, the first sidewall and the second sidewall converge relative to one another from the first end face toward the second end face.

In accordance with another aspect of the present disclosure, the slot has tapered sidewalls converging toward the second axis and the first sidewall and the second sidewall mate with the tapered sidewalls of the slot.

In accordance with another aspect of the present disclosure, a hammer includes an insert as discussed above.

In accordance with another aspect of the present disclosure, a hammer includes a handle extending along a handle axis from a first handle end to a second handle end; a head body fixed to the first handle end, the head body extending lengthwise along a first axis, generally transversely to the handle axis, between a first end and a second end; an insert defining a striking face; a key having a fastener bore extending in non-parallel relation with the first axis; and a fastener removably disposed in the fastener bore to releasably fix the insert against removal from the head body.

In accordance with another aspect of the present disclosure, the head body is provided as a monolithic piece of material with the handle.

In accordance with another aspect of the present disclosure, the head body is provided as a separate piece of material from the handle.

### BRIEF DESCRIPTION OF THE DRAWINGS

These and other features and advantages of the invention will become more readily appreciated when considered in connection with the following description of the presently preferred embodiments, appended claims and accompanying drawings, in which:

FIG. 1 is a perspective view of a hammer constructed according to a first embodiment of the present disclosure;

FIG. 2 is a perspective view of a hammer constructed to a second embodiment of the present disclosure;

FIG. 3 is a cross-sectional view taken generally along the line 3-3 of FIG. 2;

FIG. 4A is an exploded front perspective view of a head assembly of the hammer of FIG. 2 illustrating four different inserts configured for releasable attachment to a head of the hammer;

FIG. 4B is an exploded rear perspective view of the view of FIG. 4A;

FIG. 5 is an exploded front view of the hammer of FIG. 2;

FIG. 6 is a rear view of an insert of FIG. 5; and

FIG. 7 is a side view of the insert of FIG. 6 looking generally along the direction of line 7-7 of FIG. 6.

### DESCRIPTION OF THE ENABLING EMBODIMENTS

Referring to the Figures, wherein like numerals indicate corresponding parts throughout the several views, one aspect of the present invention is related to an improved hammer that has an interchangeable striking face by way of an interchangeable insert. As discussed extensively below, different inserts that have different striking faces can be quickly and very securely attached with the hammer head for different purposes.

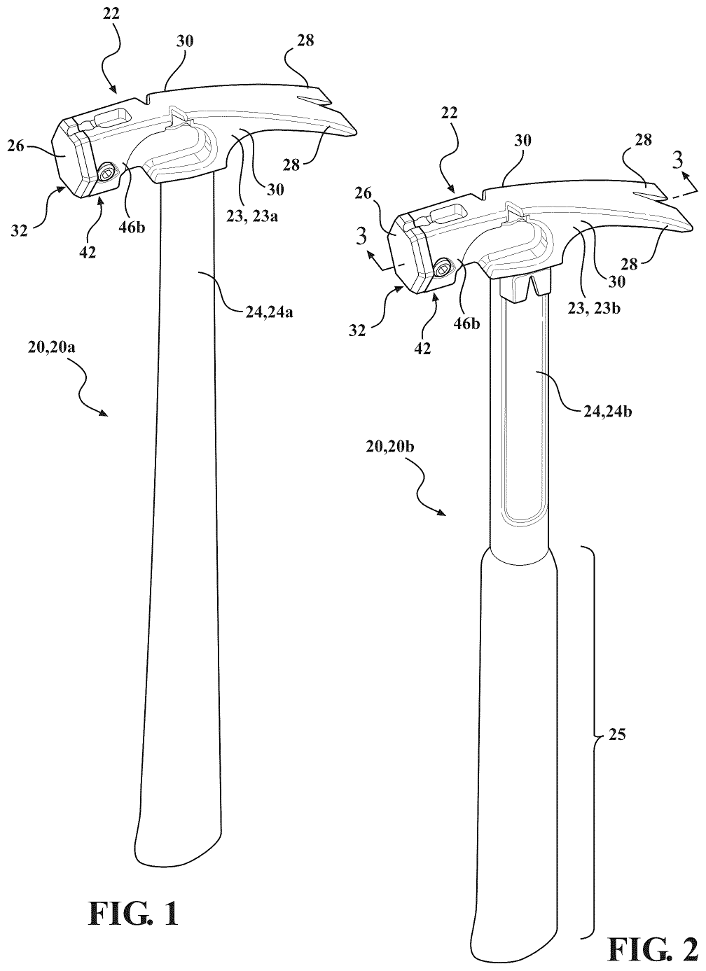

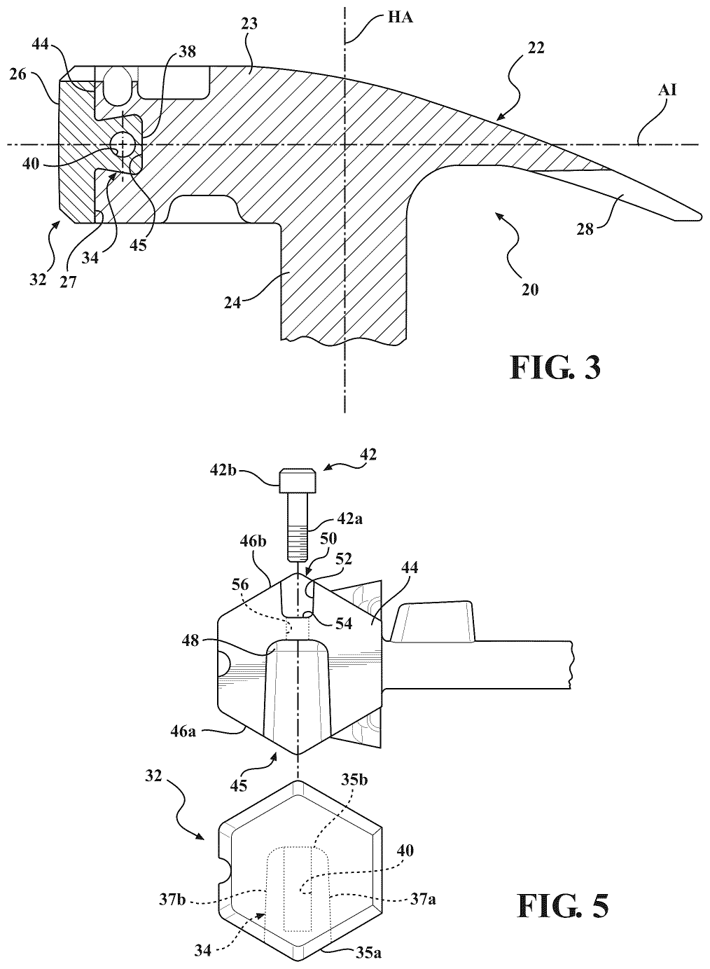

Referring to FIGS. 1 and 2, two non-limiting embodiments of hammers constructed in accordance with this disclosure are shown, respectively, referred to hereafter separately when desired to distinguish between the two different embodiments as a first hammer or hammer 20a (FIG. 1) and a second hammer or hammer 20b (FIG. 2). Otherwise, when unnecessary to distinguish between the differences of the two non-limiting embodiments, the two hammers are referred to singularly as, the hammer 20. Each of the embodiments of the hammer 20 has a head assembly 22 and a handle 24 that extends lengthwise away from a first handle end 21a fixed to the head assembly 22 along a handle axis HA to a second handle end 21b providing a gripping portion 25 where a user typically grasps the hammer 20 for use. In the exemplary non-limiting embodiments, the handle 24 of hammer 20a is made of wood (FIG. 1), and is referred to more specifically as handle 24a, and the handle 24 of hammer 20b is made of a non-wood material (FIG. 2), such as steel or a strong, tough, lightweight material (lighter than wood), for example, titanium, and is referred to more specifically as handle 24b. It is with regard to the handles 24a, 24b that the two hammers 20a, 20b are different from one another, wherein the head assemblies 22 thereof can be essentially the same, with the exception of their respective regions attached to handles 24a, 24b. When unnecessary to distinguish between the two non-limiting handles 24a, 24b, the two handles are referred to singularly as, the handle 24. The head assembly 22 extends lengthwise in a first direction along a first axis A1 (FIG. 3), which is generally transverse to the handle axis HA, with “generally” intended to include transversely and about 10 degrees +/− from transversely, from a first striking face, referred to hereafter as striking face 26, at one end, with striking face 26 being configured to impact an object being worked on, such as a nail or otherwise, to an opposite end, shown as having a pair of claws 28, typically used to pry and remove a fastener, by way of example and without limitation. It is to be understood that something other than claws 28, could be provided at the second end opposite the striking face 26, including a second striking face facing away from the first striking face 26, if desired. Accordingly, everything discussed here with regard to the striking face 26 could be provided at the second end of head assembly 22, if desired.

The head assembly 22 includes a head portion, also referred to as head body or head 23, having opposing cheeks 30 extending along opposing lateral sides, also referred to as side faces, of the head 23. The cheeks 30 lie in generally parallel planes spaced from one another by a width of the head 23, with the cheeks 30 extending generally transverse to a plane of the striking face 26. In some embodiments, the general shape of the head 23 and the handle 24 can vary depending on the intended use of the hammer 20, as will be readily understood by a person possessing ordinary skill in the art (POSA). The head 23 of hammer 20a is formed as a separate piece of material, being that the handle 24a is wood, while the head 23a is formed of any suitable metal, such as steel, titanium, or otherwise. Meanwhile, the head 23b of hammer 20b can be formed as a monolithic (single) piece of the same material as the handle 24b, such as from titanium, by way of example and without limitation. The striking face 26 of head assembly 22 is provided by an insert 32. The insert 32 is formed as a separate piece of material from the head 23 and is subsequently releasably attached to head 23 to complete head assembly 22 for use, wherein insert 32 can be readily removed for replacement, such as for a different configuration insert 32, as discussed in further detail below.

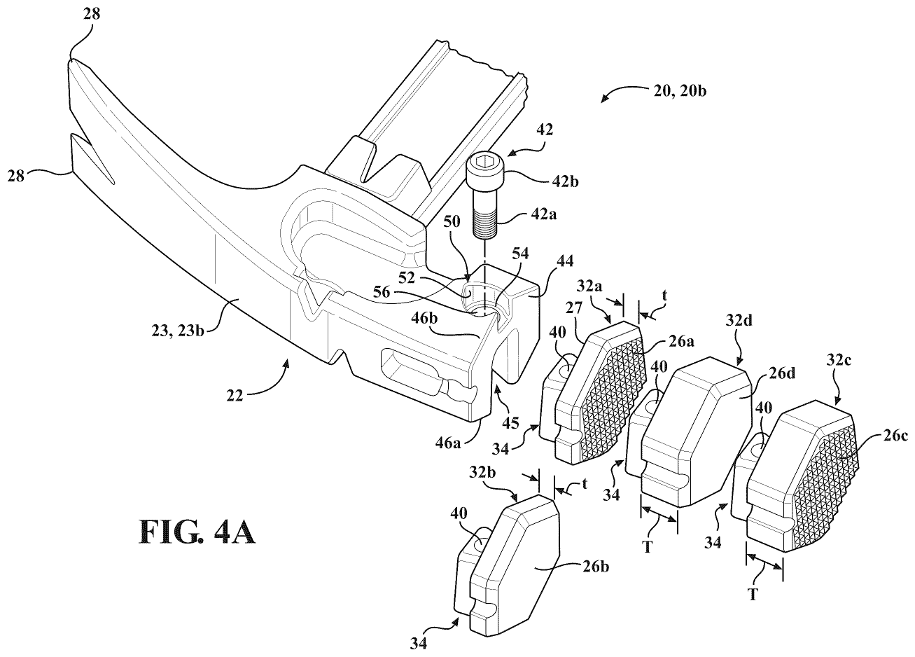

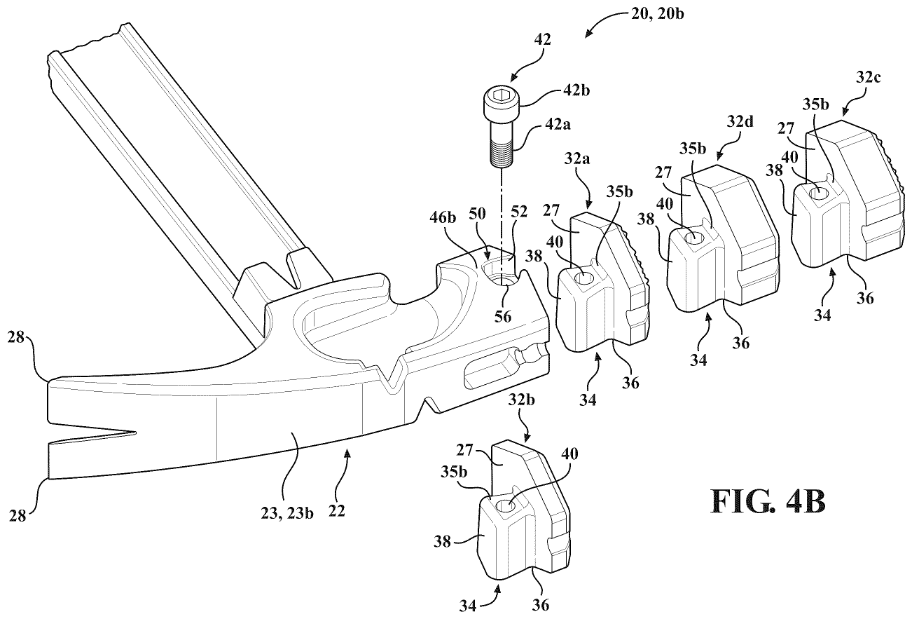

Turning now to FIGS. 4A and 4B, non-limiting alternate embodiments of inserts 32, referred to individually as inserts 32a, 32b, 32c, 32d, for sake of distinguishing the different embodiments from one another, are illustrated, each of which can be detachably secured with the head 23 for use, and subsequently removed from head 23, when desired, such as to interchange one type of insert for another, in accordance with the disclosure. When unnecessary to distinguish between the differences of the different non-limiting embodiments, the inserts 32a, 32b, 32c, 32d are referred to singularly as, the insert 32. Specifically, one of the inserts 32a has a generally planar, hexagonal striking face 26a having a thickness t extending between the striking face 26a and a back face 27 to provide a predetermined first weight, with the striking face 26a being textured, such as having a milled or otherwise formed to have dimpled, roughed surface finish; another of the inserts 32b has a similarly shaped striking face 26b and the same thickness t as the insert 32a, thereby being generally the same weight, however, the striking face 26b is generally smooth to provide a different striking functionality, such as for hitting standard nails, for example; another of the inserts 32c has a similarly shaped striking face 26c as for insert 32a, also having the same textured surface finish, however, the striking face 26c has a thickness T to provide a predetermined second weight that is greater than the first weight of insert 32a, thereby altering the weight and balance of the hammer 20, as desired by the user; and lastly, another of the inserts 32d has a similarly shaped striking face 26d and the same thickness T as the insert 32c, thereby being generally the same weight, however, the striking face 26d is generally smooth generally planar, as discussed for the insert 32b. It will be understood by a POSA that an insert in accordance with this disclosure can have a multitude of shapes, striking faces surface finishes, including a ball to function as a ball-peen hammer, sometimes referred to as a machinist's hammer, typically used for metal working, and many different weights, as desired by the user and for the intended use. Beyond having differently shaped and contoured striking faces 26, in some embodiments, the inserts 32 can be made of different materials, e.g., one insert 32 can be made of titanium for some uses, another insert 32 can be made of steel or an alloy steel for use when with concrete or when hammering steel, and yet another insert 32 can be made of a soft-blow material such as a polymeric material, e.g. Nylon, by way of example and without limitation. Accordingly, the user can quickly and easily change the functionality of the hammer 20 to attain the functionality desired for a particular use. In a particularly preferred embodiment, with reference to FIG. 2, the handle 24b and head 23b of the hammer 20b are made of a single piece of titanium, such as in a molding or casting operation, and the insert 32 is made of steel in a separate operation. In this embodiment, the hammer 20b has a relatively low weight, such as compared to an all steel hammer, since the majority of the material of the hammer 20b is light-weight titanium, while at the same time, has a hard, tough striking surface provided by the steel striking face 26.

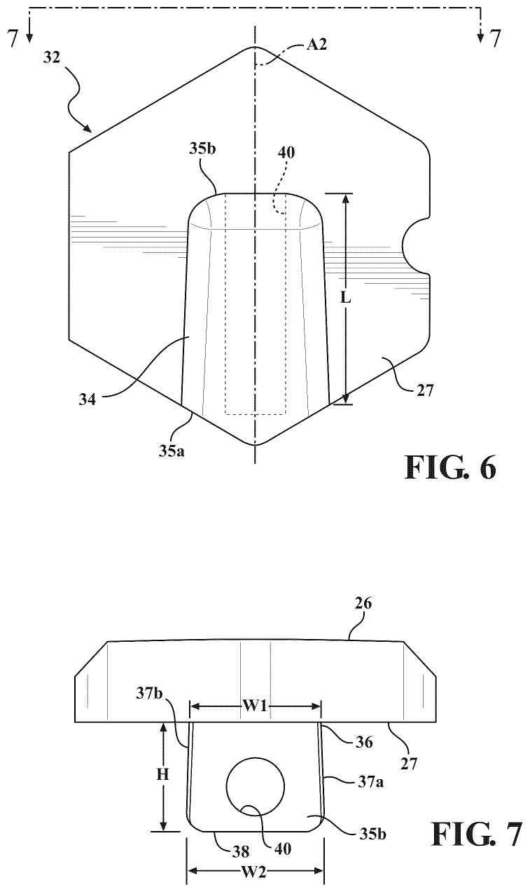

In further reference to the insert 32, opposite the respective striking face 26, the insert 32 has a key, such as a dovetail-shaped key, referred to hereafter as key 34. The key 34 has a base 36 fixed to the back face 27 and a peak 38 facing away from the back face 36, with a height H extending from the base 36 to the peak 38. The key 34 has a length L extending along a second axis A2 between a first end face 35a and an opposite second end face 35b, wherein the second axis A2 extends generally in non-parallel relation to the first axis A1, and in a non-limiting embodiment, the second axis A2 is shown extending transversely to the first axis Al upon attaching the insert 32 to the head 22a. The key 34 has a fastener bore 40 that extends into the second end face 35b, wherein fastener bore 40 has female threads configured for receipt of a fastener 42, and in particular, a male threaded shank 42a of the fastener 42. The key 34 has a width extending between opposite tapered sides, also referred to as a first sidewall 37a and an opposite second sidewall 37b. The first sidewall 37a and the second sidewall 37b extend outwardly away from the base 36 to the peak 38 such that the width of the key 34 has a first width W1 immediately adjacent or at the base 36 and a second width W2 immediately adjacent or at the peak 38, wherein the first width W1 is less than the second width W2. The width varies constantly from the base 36 to the peak 38 such that the opposite sidewalls 37a, 37b diverge continuously away from one another toward the peak 38 along a constant taper, thereby defining the dove-tail shape of the key 34. The opposite sidewalls 37a, 37b, as best seen in FIGS. 6 and 7, are further angled, also referred to as inclined or tapered to converge toward one another from the first end face 35a toward the opposite second end face 35b. Accordingly, in FIG. 7, the front of the opposite sidewalls 37a, 37b that terminate at the second end face 35b is illustrated by inner, generally vertical lines, while the back of the opposite sidewalls 37a, 37b that terminate at the first end face 35a is illustrated by outer, generally vertical lines. Accordingly, the opposite sidewalls 37a, 37b extend in non-parallel, oblique relation to the second axis A2 in constantly tapered relation to the second axis A2, thereby rendering the key 34 being wedge-shaped along its length L, as well as along its height H.

As best illustrated, in FIG. 5, the head 23 has a forward face, also referred to attachment face 44, facing away from the claws 28. The attachment face 44 has a recessed pocket, also referred to as slot 45, having a corresponding dovetail shape as discussed above for the dovetail-shaped key 34 for receiving the dovetail-shaped key 34 in mating relation therein, as discussed further below. In the exemplary embodiment, the slot 45 is shown extending into one laterally facing side surface 46a of attachment face 44 toward an opposite side surface 46b to an inwardly extending shoulder 48 in generally parallel relation with the second axis A2. The head 23 also includes a fastener opening 50 extending into the side surface 46b to the slot 45. The fastener opening 50 includes a counterbore 52 extending to a radially inwardly extending shoulder, also referred to as base 54, and a through bore 56 extending from the base 54 to the slot 45. The counterbore 52 is sized for clearance receipt of an enlarged head 42b of the fastener 42, while the through bore 56 is sized to prevent the passage of the enlarged head 42 therethrough, but provides a clearance fit with the threaded shank 42a of the fastener 42. In other words, the fastener 42 does not threadingly engage the through bore 56, but rather extends in clearance relation therethrough, thereby allowing the threaded shank 42a to only be threadingly engaged with the threaded fastener bore 40 of the insert 32, as discussed further below.

It is contemplated herein that a reversal of the key 34 and the slot 45 could be performed, such that the key could be fixed to the head 23 and the slot could be formed in the insert 32. However, it is considered preferred herein, from a manufacturing standpoint to provide the key 34 fixed to the insert 32, and the slot 45 formed in the head 23.

Securing a selected one of the inserts 32 with the head 23 of the hammer 20 is quick and straightforward, and simply requires the user to slide the dovetail-shaped key 34 of the desired insert 32 into the open end of the slot 45 from the side of the head 23. Next, the user inserts the fastener 42, such as a bolt, into the through-passage from the opposite side of the head 23 from the open end of the slot 45. The user then tightens the fastener 42 to fixedly secure the insert 32 with the head 23 to form head assembly 22. During tightening, the fastener head 42 engages the counter bore shoulder 48 of the fastener opening 50 as the threaded shank 42a of the fastener 42 threads into the threaded fastener bore 40 of the dovetail-shaped key 34 of the insert 32. As the threaded shank 42a turns, the key 34 is pulled toward the open end of the slot 45, thereby drawing the angled side walls 37a, 37b of the key 34 into a snug interference fit against the angled side walls 46a, 46b of the slot 45, thereby drawing the insert 32 into immovable fixed engagement with the head 23. With the side walls 37a, 37b of the key 34 pulled snugly against the side walls 46a, 46b of the slot 45, any impact force imparted on the striking face 26 along the second axis A2 is transmitted through the insert 32 directly to the head 23 generally along the second axis A2, and thus, the fastener 42, and particularly, the threaded shank 42a thereof, which extends in non-parallel relation, and preferably generally transversely to the second axis A2, is generally free of the impact force from being transmitted along its length, thereby avoiding any damage from being caused to the threaded shank 42a and the threaded fastener bore 40. Accordingly, during use of the hammer 20, forces at the striking face 26 are transferred directly from the insert 32 to the head 23, not through the fastener 42, and particularly not along the length of the fastener 42. This provides improved reliability by protecting the fastener 42 and threaded fastener bore 40 from damage, and also allows for a more reliable, consistent, and secure attachment between the insert 32 and the head 23 that is resistant to the fastener 42 becoming unintentionally unthreaded during use. As a result, no slop or axial play is created between the threaded shank 42a and the threaded fastener bore 40 during use of the hammer 20, and thus, the insert 32 remains firmly fixed against movement relative to the head 23, and the fastener 42 and the threaded fastener bore 40 remain undamaged. As such, the fastener 42 is able to be easily removed from the threaded fastener bore 40 without binding, when desired to remove the insert 32 from the head 23, and reused to fasten another insert 32 to the head 23, when desired. Accordingly, the attachment process can be easily reversed to detach the insert 32 from the head 23 so that a different insert 32 can be attached to the head 23.

Obviously, many modifications and variations of the present invention are possible in light of the above teachings and may be practiced otherwise than as specifically described while within the scope of the appended claims. Additionally, it is to be understood that all features of all claims and all embodiments can be combined with each other as long as they do not contradict each other. Further, it is to be understood that certain terms of direction, such as upper, lower, top, and bottom are in reference to the orientation of the hammer as shown in FIG. 1 and are not intended to be limiting.

What is claimed is:

1. A hammer head assembly, comprising:
a head body extending lengthwise along a first axis between opposite first and second ends;
an insert defining a striking face;
a key having a fastener bore extending in non-parallel relation with the first axis; and
a fastener removably disposed in the fastener bore to releasably fix the insert against removal from the head body.

2. The hammer head assembly of claim 1, wherein the fastener bore extends in transverse relation with the first axis.

3. The hammer head assembly of claim 1, wherein the head body has a slot extending into the first end, the slot extending lengthwise along a second axis in non-parallel relation to the first axis, the insert having a front face and a back face with the key fixed to the back face, the key configured for sliding receipt along the second axis into the slot, the key being shaped to avoid removal from the slot along the first axis, the fastener bore extending into the key, the fastener releasably fixing the key against removal from the slot along the second axis.

4. The hammer head assembly of claim 3, wherein the second axis extends transversely to the first axis.

5. The hammer head assembly of claim 3, wherein the fastener bore has a threaded bore and the fastener has a threaded shank and an enlarged fastener head, the head body having a fastener opening, the fastener opening including a counterbore extending to a base and a through bore extending from the base to the slot, wherein the enlarged fastener head engages the base to releasably prevent removal of the key from the slot along the second axis.

6. The hammer head assembly of claim 5, wherein the through bore has a clearance fit with the threaded shank.

7. The hammer head assembly of claim 3, wherein the slot has tapered sidewalls converging toward the second axis.

8. The hammer head assembly of claim 7, wherein the key has tapered sidewalls mating with the tapered sidewalls of the slot.

9. The hammer head assembly of claim 8, wherein the fastener, upon being tightened, draws the tapered sidewalls of the key into mating engagement with the tapered sidewalls of the slot.

10. The hammer head assembly of claim 3, wherein the key is dovetail-shaped having a base fixed to the back face and a peak facing away from the back face, the key having a height extending from the base to the peak, the key having a length extending along the second axis between a first end face and a second end face, wherein the fastener bore extends into the second end face, and the key having a width extending between a first sidewall and a second sidewall, the first sidewall and the second sidewall extending from the base to the peak, the width having a first width adjacent the base and a second width adjacent the peak, the first width being less than the second width.

11. The hammer head assembly of claim 10, wherein the first sidewall and the second sidewall converge relative to one another from the first end face toward the second end face.

12. The hammer head assembly of claim 11, wherein slot has tapered sidewalls converging toward the second axis and the first sidewall and the second sidewall mate with the tapered sidewalls of the slot.

13. A hammer, comprising:
a handle extending along a handle axis from a first handle end to a second handle end;
a head body fixed to the first handle end, the head body extending lengthwise along a first axis, generally transversely to the handle axis, between a first end and a second end;
an insert defining a striking face;
a key having a fastener bore extending in non-parallel relation with the first axis; and
a fastener removably disposed in the fastener bore to releasably fix the insert against removal from the head body.

14. The hammer of claim 13, wherein the head body has a slot extending into the first end, the slot extending lengthwise along a second axis in non-parallel relation to the first axis, the insert having a front face and a back face with the key fixed to the back face, the key configured for sliding receipt along the second axis into the slot, the key being shaped to avoid removal from the slot along the first axis, the fastener bore extending into the key, the fastener releasably fixing the key against removal from the slot along the second axis.

15. The hammer of claim 14, wherein the second axis extends transversely to the first axis.

16. The hammer of claim 14, wherein the slot has tapered sidewalls converging toward the second axis and the key has tapered sidewalls mating with the tapered sidewalls of the slot.

17. The hammer of claim 16, wherein the fastener, upon being tightened, draws the tapered sidewalls of the key into mating engagement with the tapered sidewalls of the slot.

18. The hammer of claim 14, wherein the key is dovetail-shaped having a base fixed to the back face and a peak facing away from the back face, the key having a height extending from the base to the peak, the key having a length extending along the second axis between a first end face and a second end face, wherein the fastener bore extends into the second end face, and the key having a width extending between a first sidewall and a second sidewall, the first sidewall and the second sidewall extending from the base to the peak, the width having a first width adjacent the base and a second width adjacent the peak, the first width being less than the second width.

19. The hammer of claim 18, wherein the first sidewall and the second sidewall converge relative to one another from the first end face toward the second end face.

20. The hammer of claim 19, wherein slot has tapered sidewalls converging toward the second axis and the first sidewall and the second sidewall mate with the tapered sidewalls of the slot.
